(19) United States
(12) Patent Application Publication
(10) Pub. No.: US 2014/0110058 A1
(43) Pub. Date: Apr. 24, 2014

(54) POLISHING PAD, POLISHING APPARATUS, AND METHOD FOR MAKING THE POLISHING PAD

(71) Applicant: SAN FANG CHEMICAL INDUSTRY CO., LTD., Kaohsiung City (TW)

(72) Inventors: CHUNG-CHIH FENG, KAOHSIUNG CITY (TW); I-PENG YAO, KAOHSIUNG CITY (TW); YUNG-CHANG HUNG, KAOHSIUNG CITY (TW); KUN-CHENG TSAI, KAOHSIUNG CITY (TW)

(73) Assignee: SAN FANG CHEMICAL INDUSTRY CO., LTD., Kaohsiung City (TW)

(21) Appl. No.: 14/056,709

(22) Filed: Oct. 17, 2013

(30) Foreign Application Priority Data
Oct. 18, 2012 (TW) 101138355

(51) Int. Cl. B24B 37/20; B29D 7/00

(52) U.S. Cl. CPC B24B 37/20; B29D 7/00
USPC 156/345.12; 264/250

(57) ABSTRACT

The present invention relates to a polishing pad comprising a polishing surface. The polishing surface comprises a first polishing area and a second polishing area. The first polishing area comprises a plurality of first foaming holes, and the second polishing area comprises a plurality of second foaming holes, and an average pore diameter of the first foaming holes is less than an average pore diameter of the second foaming holes. The polishing pad according to the present invention uses the polishing areas with the different pore diameters of the holes to avoid unevenly removing the edge and central part of a substrate when polishing, so that a thickness of the substrate becomes uniform.

### BACKGROUND OF THE INVENTION

1. Field of the Invention

The present invention relates to a polishing pad, a polishing apparatus and a method for making the polishing pad. Particularly, the invention relates to a polishing pad with different polishing areas, a polishing apparatus and a method for making the polishing pad.

2. Description of the Related Art

Polishing generally refers to a wear control for a preliminary coarse surface in a process of chemical mechanical polishing, which makes the slurry containing fine particles evenly dispersed on the upper surface of a polishing pad, and at the same time places a substrate against the polishing pad and then rubs the substrate repeatedly with a regular motion. The substrate may be objects such as a semiconductor, a storage medium substrate, an integrated circuit, an LCD flat-panel glass, an optical glass and a photoelectric panel. During the polishing process, a mounting sheet must be used for carrying and mounting the substrate, and the quality of the mounting sheet directly influences the polishing effect of the substrate.

FIG. 1 shows a schematic view of a polishing apparatus with a conventional polishing pad. The polishing apparatus 1 includes a lower base plate 11, a mounting sheet 12, a substrate 13, an upper base plate 14, a polishing pad 15 and slurry 16. The mounting sheet 12 is adhered to the lower base plate 11 through an adhesive layer 17 and is used for carrying and mounting the substrate 13. The polishing pad 15 is mounted on the upper base plate 14.

The operation mode of the polishing apparatus 1 is as follows. First, the substrate 13 is mounted on the mounting sheet 12, and then both the upper and lower base plates 14 and 11 are rotated and the upper base plate 14 is simultaneously moved downward, such that the polishing pad 15 contacts the surface of the substrate 13, and a polishing operation for the substrate 13 may be performed by continuously supplementing the slurry 16 and using the effect of the polishing pad 15.

At a determined rotational speed, the closer to an edge of the polishing pad in contact with the substrate, the polishing rate increases; on the contrary, the closer to a center of the polishing pad in contact with the substrate, the polishing rate decreases. Such phenomenon causes the removals of the substrate polished with the edge of the polishing pad and polished with the center of the polishing pad are inconsistent, and further causes a thickness of the substrate is not uniform.

In order to improving the uniformity of the polishing effect, U.S. Pat. No. 5,329,734 discloses a polishing pad comprising openings on a surface. The polishing pad has a first region that lies closer to the edge of the polishing pad and a second region that lies further from the edge of the polishing pad. The second region has a plurality of openings or a larger average pore size compared to the first region. In the polishing process, slurry can stay in the openings, and the second region can carry more slurry to balance the inconsistent polishing effect due to the uneven polishing rate. However, the openings are formed with an additional processing after the polishing pad manufacture is completed, and the processing is time-consuming and cost-consuming. The manners of forming the openings in the conventional polishing pad are listed below. (1) Machining, such as forming the openings with the use of cutting, milling, punching, etc. However, because finesse of the processing is not satisfactory, the alignment of the openings is merely a simple and fixed pattern (such as a concentric circle, etc.). Additionally, because size, location, and depth controls of the openings are not easy in this processing, the uniform distribution of the openings is difficult to achieve, and the uniformity of polishing is further affected. Besides, residues are also produced in the processing, and an additional removal is needed. (2) High-energy laser drilling. The high-energy laser can produce openings on the surface of the polishing pad. However, the laser also produces sintered points that pollute the polishing pad, and scratch the substrate. It leads inconsistent quality of polishing and the processing is too time-consuming also.

Therefore, it is needed to provide a novel and improved polishing pad, a polishing apparatus and a method for making the polishing pad to resolve the problems mentioned above.

### SUMMARY OF THE INVENTION

The present invention provides a polishing pad; wherein a polishing surface has different foaming holes to improve the uniformity of the removals of the substrate polished with the edge of the polishing pad and polished with the center of the polishing pad, and to improve the uniformity of the thickness of the substrate.

The present invention provides a polishing pad, comprising a polishing surface having a foaming resin, wherein the polishing surface comprises:

a first polishing area comprising a plurality of first foaming holes; and

a second polishing area comprising a plurality of second foaming holes;

wherein an average pore diameter of the first foaming holes is less than an average pore diameter of the second foaming holes.

The present invention also provides a polishing apparatus comprising:
a base plate;
a substrate;
the polishing pad as mentioned above adhered to the base plate for polishing the substrate; and
slurry contacting the substrate for polishing.

The present invention further provides a method for making the polishing pad as mentioned above, comprising:

(a) providing a first polymer composition and a second polymer composition, wherein a viscosity of the first polymer composition is less than a viscosity of the second polymer composition;

(b) forming the second polishing area with the second polymer composition; and

(c) forming the first polishing area with the first polymer composition.

### BRIEF DESCRIPTION OF THE DRAWINGS

FIG. 1 shows a schematic view of a polishing apparatus with a conventional polishing pad.

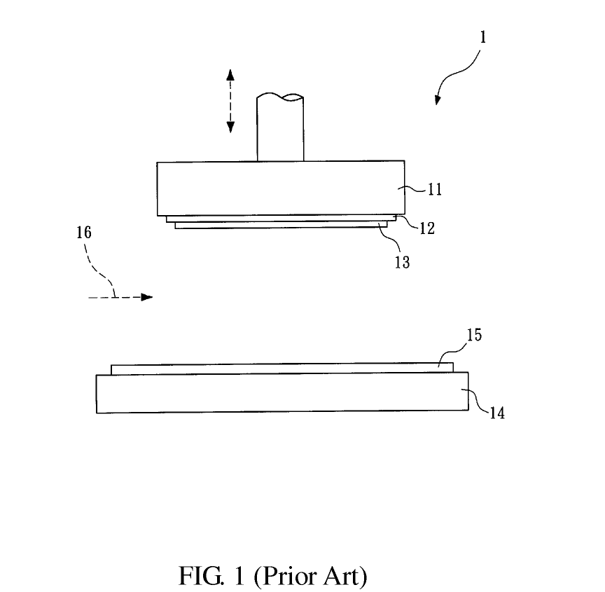

FIG. 2 shows a schematic view of a polishing surface according to a first embodiment of the invention.

FIG. 3 shows a schematic view of a polishing surface according to a second embodiment of the invention.

FIG. 4 shows a schematic view of a polishing surface according to a third embodiment of the invention.

FIG. 5 shows a schematic view of a polishing apparatus with a polishing pad according to the invention.

### DETAILED DESCRIPTION OF THE INVENTION

The present invention provides a polishing pad, comprising a polishing surface having a foaming resin, wherein the polishing surface comprises:

a first polishing area comprising a plurality of first foaming holes; and

a second polishing area comprising a plurality of second foaming holes;

wherein an average pore diameter of the first foaming holes is less than an average pore diameter of the second foaming holes.

The term “polishing pad” as used herein refers to a structure for planarizing a substrate in a process of chemical mechanical polishing. Preferably, the polishing pad is coordinated with slurry to conduct the process of chemical mechanical polishing. Preferably, the polishing pad comprises a polishing surface for polishing the substrate. The polishing pad is preferably a sheet and able to be adhered to a polishing apparatus.

In one embodiment of the invention, a material of the polishing pad is a foaming resin. The material of the polishing pad can be used independently or in combinations according to properties needed. As used herein, the term “foaming resin” refers to a material containing a thermoplastic resin and a thermodecomposing foaming agent. The material of the polishing pad is for polishing the substrate, and exampled as an elastomer. As used herein, the term “elastomer,” also known as “elastic polymer,” refers to a type of polymer that exhibits rubber-like qualities. When polishing, the elastomer serves as a good buffer to avoid scraping a surface of the substrate to be polished. In one preferred embodiment of the invention, the foaming resin is foaming polyurethane, polyolefin, polycarbonate, polyvinyl alcohol, nylon, elastic rubber, polystyrene, poly-aromatic molecule, fluoropolymer, polyimide, cross-linked polyurethane, cross-linked polyolefin, polyether, acrylate, polyacrylate, flexible polyethylene, polytetrafluoroethylene, poly (ethylene terephthalate), poly aromatic amide, polymethyl methacrylate, diisocyanate, copolymers thereof, block copolymers thereof, and mixtures or blends thereof.

The “substrate” as used herein refers to a substrate to be polished, preferably a panel. In one embodiment of the invention, the substrate is a semiconductor, a storage medium substrate, an integrated circuit, an LCD flat-panel glass, an optical glass and a photoelectric panel.

The polishing surface according to the invention comprises a first polishing area comprising a plurality of first foaming holes and a second polishing area comprising a plurality of second foaming holes. An average pore diameter of the first foaming holes is less than an average pore diameter of the second foaming holes. The corresponding alignment of the first polishing area and the second polishing area may be predetermined or random.

As used herein, the term “average pore diameter” refers to an average value of pore diameters of the foaming holes in one polishing area. Preferably, the pore diameter of a hole refers to a sectional size of the foaming holes. In one preferred embodiment of the invention, the average pore diameter of the first foaming holes is determined as (a total area of the first foaming holes on a sectional surface of the first polishing area)/(a total number of the first foaming holes on the sectional surface of the first polishing area); and the average pore diameter of the second foaming holes is determined as (a total area of the second foaming holes on a sectional surface of the second polishing area)/(a total number of the second foaming holes on the sectional surface of the second polishing area).

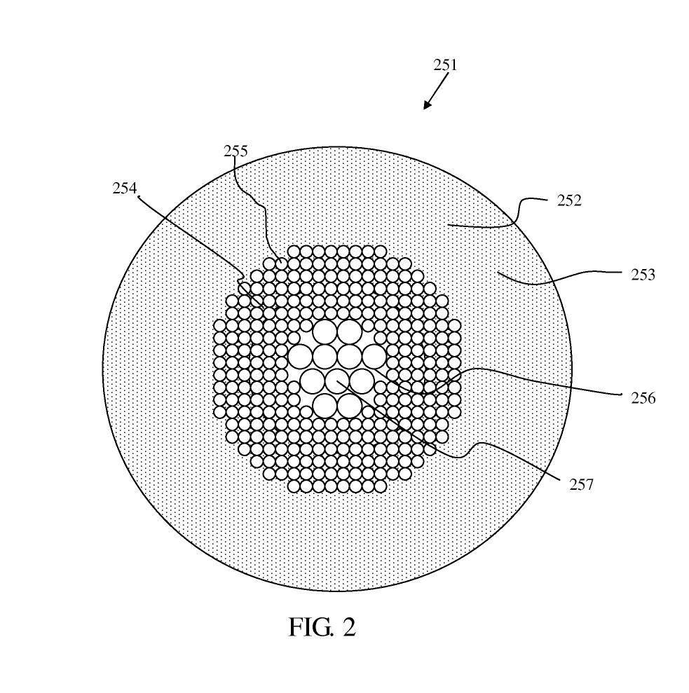

Referring to FIG. 2 showing a schematic view of a polishing surface 251 according to a first embodiment of the invention. The polishing surface 251 comprises a first polishing area 252 and a second polishing area 254. The first polishing area 252 comprises a plurality of first foaming holes 253. The second polishing area 254 comprises a plurality of second foaming holes 255. An average pore diameter of the first foaming holes 253 is less than an average pore diameter of the second foaming holes 255. The first polishing area 252 surrounds the second polishing area 254. Preferably, The first polishing area 252 completely surrounds the second polishing area 254. Because the first polishing area 252 is located in the periphery of the polishing surface 251, a tangential velocity thereof is greater when polishing at a determined rotational speed. Therefore, the average pore diameter of the first foaming holes 253 is less allowing less slurry stayed therein. On the other hand, because the second polishing area 254 is located near the center of the polishing surface 251, a tangential velocity is less when polishing at the determined rotational speed. Therefore, the average pore diameter of the second foaming holes 255 is greater allowing more slurry stayed therein. As the result, the amount of slurry and tangential velocities are balanced to achieve consistent polishing effect.

According to the invention, the foaming holes are formed without additional processing after the polishing pad manufacture is completed, and the time and cost is saved. Additionally, the formation and alignment of the foaming holes with different pore diameters is produced along with the polishing pad manufacture. The problems of sintering or residues occurred in the conventional polishing pad manufacture are avoided. The polishing pad according to the invention improves the uniformity of the removals of the substrate polished with the edge of the polishing pad and polished with the center of the polishing pad, and improves the uniformity of the thickness of the substrate.

In one preferred embodiment of the invention, the polishing surface 251 further comprises a third polishing area 256, and the third polishing area 256 comprises a plurality of third foaming holes 257, and an average pore diameter of the third foaming holes 257 is greater than the average pore diameter of the second foaming holes 255. In one preferred embodiment of the invention, the average pore diameter of the third foaming holes is determined as (a total area of the third foaming holes 257 on a sectional surface of the third polishing area 256)/(a total number of the third foaming holes 257 on the sectional surface of the third polishing area 256). The corporation of the third polishing area 256, first polishing pad area 252 and second polishing area 254 provides a more flexible and divergent polishing alignment, especially for applying the polishing pad in polishing a substrate with fine surface. The corresponding alignment of the first polishing pad area 252, second polishing area 254 and third polishing area 256 may be predetermined or random. Preferably, the second polishing area 254 surrounds the third polishing area 256. More preferably, the second polishing area 254 completely surrounds the third polishing area 256.

A shape of the first polishing area 252 or the second polishing area 254 may be random. Preferably, the shape of the first polishing area 252 or the second polishing area 254 is the same to that of the polishing pad. In one preferred embodiment of the invention, the shape of the first polishing area 252 or the second polishing area 254 is a square, circle or polygon. In other aspect, the first polishing area 252 and the second polishing area 254 are concentric.

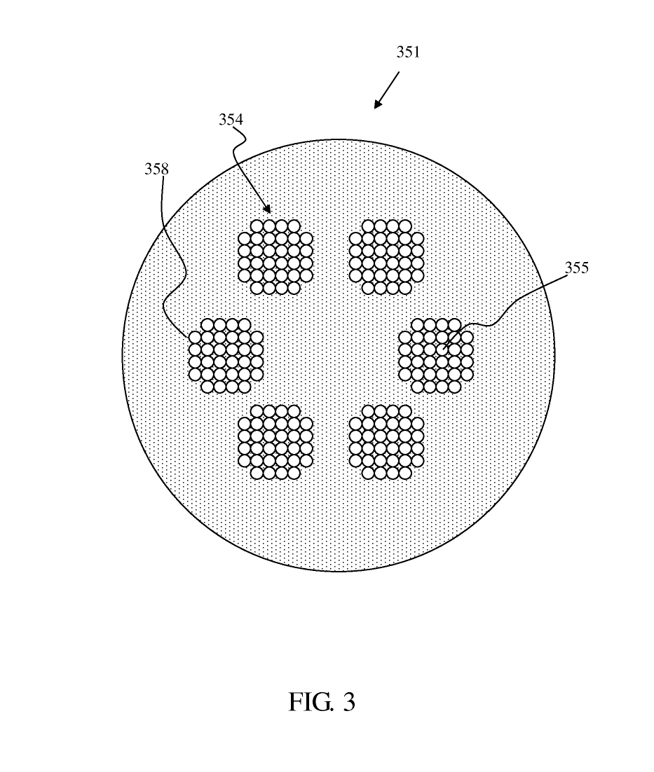

Preferably, the second polishing area comprises a plurality of second polishing parts. Referring to FIG. 3 showing a schematic view of a polishing surface 351 according to a second embodiment of the invention. The second polishing area 354 comprises a plurality of second polishing parts 358. The second polishing area 354 comprises a plurality of second foaming holes 355. The plurality of second foaming holes 355 form one of the second polishing part 358, and the plurality of second foaming parts 358 forms the second polishing area 354.

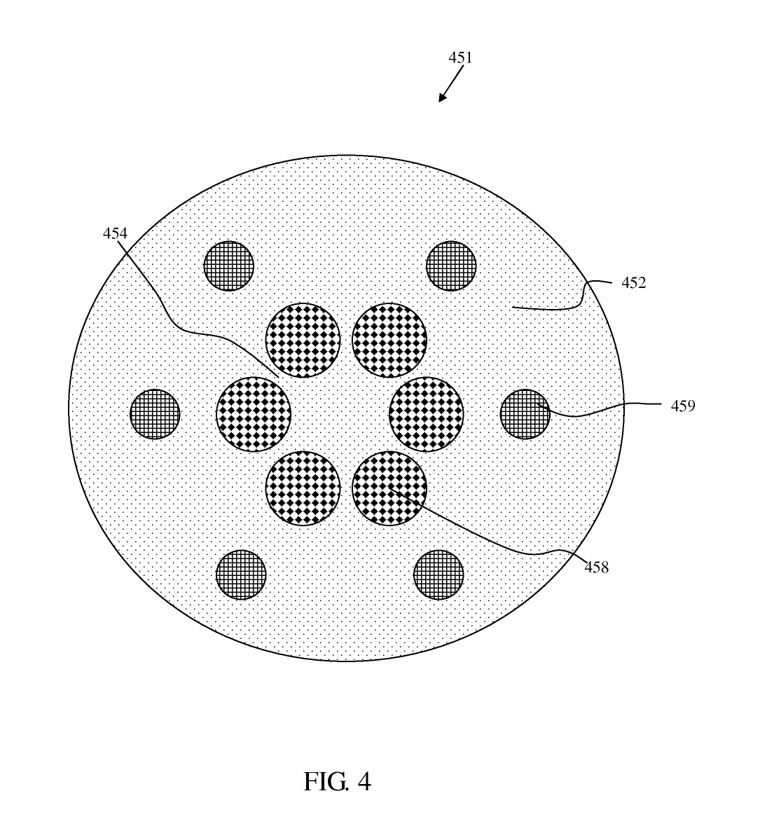

Referring to FIG. 4 showing a schematic view of a polishing surface 451 according to a second embodiment of the invention. The polishing surface 451 comprises a first polishing area 452 and a second polishing area 454. The first polishing area 452 comprises a plurality of first polishing parts 459 and the second polishing area 454 comprises a plurality of second polishing parts 458, and the first polishing parts 459 and the second polishing parts 458 extend radially from a center of the polishing pad.

Difference of the average pore diameter of the first foaming holes and the second foaming holes can be adjusted by artisans skilled in this field. In one preferred embodiment of the invention, the average pore diameters are adjusted by adjusting porosities of the first polishing area and the second polishing area; wherein the porosity of the first polishing area is less than the porosity of the second polishing area. As used herein, the term “porosity” refers to a rate of a total volume of the foaming holes per unit volume. The manner of determining the porosity is not limited, such as determining numbers of the foaming holes on a longitudinal-sectional surface, cross-sectional surface and flat-sectional surface, separately, with a scanning electron microscope and calculating a total number of the foaming holes in the polishing surface; determining an average volume of the foaming holes; calculating a total volume of the foaming holes with the total number of the foaming holes and the average volume of the foaming holes; and dividing the total volume of the foaming holes with the total volume of the polishing area to obtain the porosity.

Preferably, the average pore diameter of the foaming holes according to the invention is from about 10 μm to about 1000 μm; preferably from about 10 μm to about 100 μm; more preferably from about 10 μm to about 20 μm.

In another aspect, a difference of the average pore diameter of the first foaming holes and the average pore diameter of the second foaming holes is less than about 500 μm; preferably less than about 00 μm; more preferably less than about 50 μm.

The present invention also provides a polishing apparatus comprising:
a base plate;
a substrate;
the polishing pad as mentioned above adhered to the base plate for polishing the substrate; and
slurry contacting the substrate for polishing.

Preferably, the polishing apparatus further comprises:
an upper base plate positioned opposite to the base plate; and
a mounting sheet adhered to the upper base plate for mounting and securing the substrate.

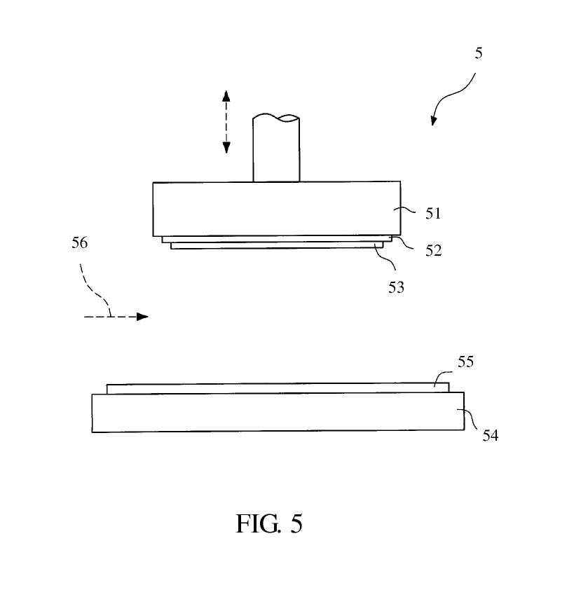

FIG. 5 shows a schematic view of a polishing apparatus with a polishing pad according to the invention. The polishing apparatus 5 includes a lower base plate 51, a mounting sheet 52, a substrate 53, an upper base plate 54, a polishing pad 55 and slurry 56. The mounting sheet 52 is adhered to the lower base plate 51 through an adhesive layer 57 and is used for carrying and mounting the substrate 53. The polishing pad 55 is mounted on the upper base plate 54.

The operation mode of the polishing apparatus 5 is as follows. First, the substrate 53 is mounted on the mounting sheet 52, and then both the upper and lower base plates 54 and 51 are rotated and the upper base plate 54 is simultaneously moved downward, such that the polishing pad 55 contacts the surface of the substrate 53, and a polishing operation for the substrate 53 may be performed by continuously supplementing the slurry 56 and using the effect of the polishing pad 55.

The present invention further provides a method for making the polishing pad as mentioned above, comprising:

(a) providing a first polymer composition and a second polymer composition, wherein a viscosity of the first polymer composition is less than a viscosity of the second polymer composition;

(b) forming the second polishing area with the second polymer composition; and

(c) forming the first polishing area with the first polymer composition.

In the method according to the invention, the step (a) is to provide a first polymer composition and a second polymer composition, and the first polymer composition and the second polymer composition are for forming the polishing surface. Materials of the first polymer composition and the second polymer composition are as mentioned above. The formulation of the first polymer composition and the second polymer composition and the manner of making may be chosen by artisans skilled in this field according to the average pore diameter of the foaming holes. Because a viscosity of the first polymer composition is less than a viscosity of the second polymer composition, the average pore diameter of the first foaming holes is less than the average pore diameter of the second foaming holes.

The manner of the steps (b) and (c) in the method according to the invention of forming the second polishing area with the second polymer composition and forming the first polishing area with the first polymer composition may be chosen by artisans skilled in this field. In one embodiment of the invention, the steps comprise filing the first polymer composition or the second polymer composition in a mold and curing. The manner of curing may be chosen by artisans skilled in this field according to the kind of the polymer and properties needed.

Preferably, the method further comprising a skiving step which is skiving the cured polymer compositions into a polishing pad with a sheet shape. The manner of skiving may be chosen by artisans skilled in this field.

In a first preferred embodiment of the invention, the method comprises:

(1) providing a first mold and a second mold; wherein the first mold corresponds to the first polishing area, and the second mold corresponds to the second polishing area;

(2) filing a cavity of the second mold with the second polymer composition;

(3) filing a cavity of the first mold with the first polymer composition; and

(4) curing the first polymer composition and the second polymer composition and removing the first mold and the second mold.

In a second preferred embodiment of the invention, the method comprises:

(i) providing a first mold and a second mold; wherein the first mold corresponds to the first polishing area, and the second mold corresponds to the second polishing area;

(ii) filing a cavity of the second mold with the second polymer composition, and removing the second mold;

(iii) filing a cavity of the first mold with the first polymer composition, and removing the first mold, and curing the first polymer composition and the second polymer composition.

In a third preferred embodiment of the invention, the method comprises:

(I) providing a first mold, wherein the first mold corresponds to the first polishing area;

(II) forming the second polishing area with the second polymer composition, and curing the second polymer composition; and

(III) placing the cured second polymer composition in a cavity of the first mold, and filing the cavity of the first mold with the first polymer composition, and curing the first polymer composition and removing the first mold.

The following Examples are given for the purpose of illustration only and are not intended to limit the scope of the present invention.

### Example 1

A first polymer composition with a viscosity of 750 cps and a second polymer composition with a viscosity of 3600 cps are prepared. The first polymer composition and the second polymer composition are a mixture of diisocyanate, polyamide and polyester. The above first and second polymer compositions are filled into a mold with two-layered columns. A second polymer composition is filled in a central column and a first polymer composition is filled in a peripheral column. The compositions are cured at 80° C. for 45 minutes and then dried at 110° C. for 16 hours in a oven after removed from the mold and further subjected to skiving. After skiving, a polishing pad has 10-μm average pore diameter of first foaming holes and 50-μm average pore diameter of second foaming holes is produced.

### Example 2

A first polymer composition with a viscosity of 550 cps, a second polymer composition with a viscosity of 4000 cps and a third polymer composition with a viscosity of 4200 cps are prepared. The first polymer composition, the second polymer composition and the third polymer composition are a mixture of diisocyanate, polyamide and polyester. Circle molds with diameters of 400 mm (third mold), 800 mm (second mold) and 1000 mm (first mold) are placed in a square mold with 1200 mm×1200 mm. The third polymer composition is filled in a cavity of the third mold and the third mold is removed. The second polymer composition is filled in a cavity of the second mold and the second mold is removed. The first polymer composition is filled in a cavity of the first mold and the first mold is removed.

The compositions are cured at 80° C. for 45 minutes in the square mold and then dried at 110° C. for 16 hours in a oven after removed from the mold and further subjected to skiving. After skiving, a polishing pad has 10-μm average pore diameter of first foaming holes, 50-μm average pore diameter of second foaming holes, and 100-μm average pore diameter of third foaming holes is produced (as shown in FIG. 2).

### Example 3

A first polymer composition with a viscosity of 650 cps and a second polymer composition with a viscosity of 3850 cps are prepared. The first polymer composition and the second polymer composition are a mixture of diisocyanate, polyamide and polyester.

A second mold is provided and the second polymer composition is filled in a cavity of the second mold. The second polymer composition is cured at 80° C. for 45 minutes in the second mold and then dried at 110° C. for 16 hours in a oven after removed from the second mold and further subjected to skiving for obtaining six circle blocks with 500-mm diameter. The six circle blocks with 500-mm diameter are placed in a square first mold with 1200 mm×1200 mm. The first polymer composition is filled in a cavity of the first mold. The first polymer composition is cured at 80° C. for 45 minutes in the square mold and then dried at 110° C. for 16 hours in a oven after removed from the first mold and further subjected to skiving. After skiving, a polishing pad has 10-μm average pore diameter of first foaming holes and 50-μm average pore diameter of second foaming holes is produced.

While embodiments of the present invention have been illustrated and described, various modifications and improvements can be made by persons skilled in the art. The embodiments of the present invention are therefore described in an illustrative but not restrictive sense. It is intended that the present invention is not limited to the particular forms as illustrated, and that all the modifications not departing from the spirit and scope of the present invention are within the scope as defined in the appended claims.

What is claimed is:

1. A polishing pad, comprising a polishing surface having a foaming resin, wherein the polishing surface comprises:
a first polishing area comprising a plurality of first foaming holes; and
a second polishing area comprising a plurality of second foaming holes;
wherein an average pore diameter of the first foaming holes is less than an average pore diameter of the second foaming holes.

2. The polishing pad according to claim 1, wherein the first polishing area surrounds the second polishing area.

3. The polishing pad according to claim 1, wherein the polishing surface further comprises a third polishing area, and the third polishing area comprises a plurality of third foaming holes, and an average pore diameter of the third foaming holes is greater than the average pore diameter of the second foaming holes.

4. The polishing pad according to claim 3, wherein the second polishing area surrounds the third polishing area.

5. The polishing pad according to claim 1, wherein the first polishing area and the second polishing area are concentric.

6. The polishing pad according to claim 1, wherein the second polishing area comprises a plurality of second polishing parts; the plurality of second foaming holes forms one of the second polishing part; and the plurality of second foaming parts forms the second polishing area.

7. The polishing pad according to claim 1, wherein the second polishing area comprises a plurality of second polishing parts.

8. The polishing pad according to claim 1, wherein the first polishing area comprises a plurality of first polishing parts and the second polishing area comprises a plurality of second polishing parts, and the first polishing parts and the second polishing parts extend radially from a center of the polishing pad.

9. The polishing pad according to claim 1, wherein a porosity of the first polishing area is less than a porosity of the second polishing area.

10. A polishing apparatus comprising:
a base plate;
a substrate;
the polishing pad as claimed in claim 1 adhered to the base plate for polishing the substrate; and
slurry contacting the substrate for polishing.

11. A method for making the polishing pad according to claim 1, comprising:
(a) providing a first polymer composition and a second polymer composition, wherein a viscosity of the first polymer composition is less than a viscosity of the second polymer composition;
(b) forming the second polishing area with the second polymer composition; and
(c) forming the first polishing area with the first polymer composition.

12. The method according to claim 11, comprising:
(1) providing a first mold and a second mold; wherein the first mold corresponds to the first polishing area, and the second mold corresponds to the second polishing area;
(2) filing a cavity of the second mold with the second polymer composition;
(3) filing a cavity of the first mold with the first polymer composition; and
(4) curing the first polymer composition and the second polymer composition and removing the first mold and the second mold.

13. The method according to claim 11, comprising:
(i) providing a first mold and a second mold; wherein the first mold corresponds to the first polishing area, and the second mold corresponds to the second polishing area;
(ii) filing a cavity of the second mold with the second polymer composition, and removing the second mold;
(iii) filing a cavity of the first mold with the first polymer composition, and removing the first mold, and curing the first polymer composition and the second polymer composition.

14. The method according to claim 11, comprising:
(I) providing a first mold, wherein the first mold corresponds to the first polishing area;
(II) forming the second polishing area with the second polymer composition, and curing the second polymer composition; and
(III) placing the cured second polymer composition in a cavity of the first mold, and filing the cavity of the first mold with the first polymer composition, and curing the first polymer composition and removing the first mold.
